(19) United States
(12) Patent Application Publication
(10) Pub. No.: US 2010/0266863 A1
(43) Pub. Date: Oct. 21, 2010

(54) Sn-PLATED MATERIALS FOR ELECTRONIC COMPONENTS

(75) Inventor: Koichiro Tanaka, Ibaraki (JP)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: NIPPON MINING & METALS CO., LTD., Tokyo (JP)

(21) Appl. No.: 12/740,784

(22) PCT Filed: Oct. 30, 2008
(86) PCT No.: PCT/JP2008/069787

§ 371 Date: Apr. 30, 2010

(30) Foreign Application Priority Data
Oct. 31, 2007 (JP) 2007-284016

(51) Int. Cl. B32B 15/01; B05D 3/02

(52) U.S. Cl. 428/555; 427/383.1

(57) ABSTRACT

There is provided a Sn-plated material comprising a base plated layer made of Ni or a Ni alloy having a thickness of 0.2 to 1.5 μm, an intermediate plated layer made of a Cu—Sn alloy having a thickness of 0.1 to 1.5 μm, and a surface plated layer made of Sn or a Sn alloy having a thickness of 0.1 to 1.5 μm in this order on the surface of copper or a copper alloy, and the mean crystal particle size of the Cu—Sn alloy forming the intermediate plated layer is 0.05 μm or larger but is smaller than 0.5 μm when a cross section of the intermediate plated layer is observed.

### TECHNICAL FIELD

The present invention relates to a Sn-plated material that is suitable as a conductive spring material for electronic components, particularly, connectors, terminals, and the likes.

### BACKGROUND ART

As conductive spring materials for terminals, connectors, and the likes, Sn-plated copper or Sn-plated copper alloy strips (hereinafter referred to as “Sn-plated materials”) are used. A Sn-plated material is normally manufactured by forming a Cu-base plated layer by an electroplating technique after degreasing and pickling in a successive plating line, then forming a Sn layer by an electroplating technique, and then performing a reflow process to melt the Sn layer.

As the number of circuits in each electronic or electric component has become larger in recent years, connectors for supplying electric signals to circuits are more and more multipolarized. Because of its softness, a Sn-plated material has a gastight structure that clumps a male terminal and a female terminal at a contact point between connectors. Therefore, a Sn-plated material has larger connector insertion force for each pole than the insertion force of a connector formed with gold plating or the like. The multipolarized connectors cause the problem of an increase in connector insertion force.

In an automobile assembly line, for example, connectors are normally engaged with one another manually. If the connector insertion force becomes larger, more loads are imposed on the workers working on the assembly line, directly resulting in degradation of work efficiency. Furthermore, there is an indication that the health of each worker might be adversely affected. In view of this, there is a strong demand for a reduction of the insertion force of each Sn-plated material.

In a Sn-plated material, the constituents of the substrate and the base plating diffuse into the Sn layer over time, and form an alloy phase. As a result, the Sn layer disappears, and the properties such as contact resistance and solderability are degraded. In the case of Sn plating with Cu-base plating on copper or a copper alloy, the alloy phase is mainly an intermetallic compound such as Cu₆Sn₅ or Cu₃Sn, and the time degradation of the properties is accelerated at higher temperatures.

There are cases where plated products are left over a long period of time before being used, due to an overseas transfer of the manufacturing base of the connector manufacturer. Therefore, there is a demand for a material that does not deteriorate in the plated material properties or has high non-aging characteristics even if it is stored over a long period of time. Property degradation of plated materials is accelerated at high temperatures. Therefore, a material that does not show significant property degradation at a high temperature or has high heat resistance is, in other words, a material that has resistance to property degradation even if being stored over a long period of time.

Furthermore, Pb-free soldering is becoming more and more common as an environmental measure. The mounting temperature of the soldering is higher than that for the conventional Pb—Sn soldering. In view of this, high heat resistance is necessary.

As described above, a reduction of insertion force and improvement of heat resistance have been the goal for Sn-plated materials to achieve in recent years.

In a Sn-plated material, the insertion force can be reduced by making the Sn-plated layer thinner. On the other hand, the heat resistance can be made higher by making the Sn-plated layer thicker. To achieve low insertion force and high heat resistance at the same time in a Sn-plated material, the base plated layer is formed with a Ni layer and a Cu layer, and a reflow process is performed after surface Sn plating, thereby a Sn-plated material of a three-layer structure that includes a Ni layer, a Cu—Sn alloy layer, and a Sn layer is obtained. In this manner, the heat resistance is made higher while the thickness of the Sn-plated layer is reduced.

Japanese Patent Application Laid-Open No. 2002-226982 discloses a method for manufacturing a heat-resistant coating by performing a reflow process after a Ni or Ni-alloy layer, a Cu layer, and a Sn or Sn-alloy layer are formed to cover the material surface in this order from the surface side (claim 6). The heat-resistant coating includes the Sn or Sn-alloy layer having a thickness X of 0.05 to 2 μm on the outermost surface, an alloy layer containing an intermetallic compound having Cu—Sn as a main component with a thickness Y of 0.05 to 2 μm on the inner side of the Sn or Sn-alloy layer, and the Ni or Ni-alloy layer having a thickness Z of 0.01 to 1 μm on the inner side of the alloy layer (claim 1). This document also discloses that the surface roughness of the material should fall within a predetermined range, so that the surface smoothness of each layer covering the material is stabilized, and the adhesiveness and exterior appearance are improved (paragraph 0010). The document also specifies that the reflow process is preferably performed at a temperature of 300 to 900° C. for 1 to 300 seconds (paragraph 0011).

Japanese Patent Application Laid-Open No. 2004-68026 discloses a conductive material for connecting components. The conductive material is manufactured by forming a Ni layer, a Cu—Sn alloy layer, and a surface plated layer made of a Sn layer in this order on the surface of a substrate made of Cu or a Cu alloy. The thickness of the Ni layer is 0.1 to 1.0 the thickness of the Cu—Sn alloy layer is 0.1 to 1.0 the Cu density in the Cu—Sn alloy layer is 35 to 75 atomic %, and the thickness of the Sn layer is 0.5 μm or smaller (claim 2). This document also discloses that the carbon amount in the Sn layer should be restricted to 0.001 to 0.1 mass %, to achieve uniform electrodeposition of Sn plating (paragraph 0013).

This document also discloses a method for manufacturing a conductive material for connecting components. In the conductive material, a Ni-plated layer having a thickness of 0.1 to 1.0 μm, a Cu-plated layer having a thickness of 0.1 to 0.45 μm, and a surface plated layer formed with a Sn layer that contains 0.001 to 0.1 mass % of carbon and has a thickness of 0.4 to 1.1 μm are formed in this order on the surface of a substrate made of Cu or a Cu alloy. After the formation of those layers, a heat treatment is carried out to form a Cu—Sn alloy layer, and the surface plated layer having a Ni layer, the Cu—Sn alloy layer, and a Sn layer is formed (claim 10). This document also discloses that a reflow process as the heat treatment is carried out at a temperature of 230 to 600° C. for 3 to 30 seconds (paragraph 0019).

Japanese Patent No. 3,880,877 discloses a plated copper and a plated copper alloy that are characterized in that a Ni or Ni-alloy layer is formed on the surface of copper or a copper alloy, a Sn or Sn-alloy layer having a thickness of 0.25 to 1.5 μm is formed on the side of the outermost surface, one or more intermediate layers containing Cu and Sn are formed between the Ni or Ni-alloy layer and the Sn or Sn-alloy layer, and the intermediate layer in contact with the Sn or Sn-alloy layer among those intermediate layers has a Cu content of 50 weight % or less, has a Ni content of 20 weight % or less, and a mean crystal particle size of 0.5 to 3.0 μm. The mean crystal particle size of the intermediate layers is measured with the use of an electrolytic film thickness meter, the surface of each sample after the Sn layer is removed from the sample is observed by SEM, and the mean crystal particle size is calculated by JIS H0501 (planimetric method) (paragraph 0063).

This document also discloses a method for manufacturing a plated copper and a plated copper alloy by performing Ni or Ni-alloy plating of 0.05 to 1.0 μm in thickness on the surface of copper or a copper alloy, performing Cu plating of 0.03 to 1.0 μm in thickness, performing Sn or Sn-alloy plating of 0.15 to 3.0 μm in thickness on the outermost surface, and forming one or more intermediate layers containing Sn or Sn alloy between the Ni or Ni-alloy plating and the Sn or Sn-alloy layer by performing a heating treatment at least once and then cooling the sample. This method is characterized in that the heating treatment is performed at a temperature of 400 to 900° C., the cooling is performed so that the time from when the Sn or Sn-alloy layer is melted till when the Sn or Sn-alloy layer is solidified is 0.05 to 60 seconds, and the intermediate layer in contact with the Sn or Sn-alloy layer among the intermediate layers has a mean crystal particle size of 0.5 to 3.0 μm.

Patent Document 1: Japanese Patent Application Laid-Open No. 2002-226982

Patent Document 2: Japanese Patent Application Laid-Open No. 2004-68026

Patent Document 3: Japanese Patent No. 3,880,877

### DISCLOSURE OF THE INVENTION

### Problems to be Solved by the Invention

As described above, the characteristics of a Sn-plated material of a three-layer structure that includes a Ni layer, a Cu—Sn alloy layer, and a Sn layer have been improved by controlling the thickness of each plated layer, the roughness of the material, the content of a particular element in the layers, and the mean crystal particle size in the Cu—Sn diffusion layer when the Sn layer is removed and the sample is observed from the plated face. However, such a Sn-plated material of a three-layer structure including a Ni layer, a Cu—Sn alloy layer, and a Sn layer has room for improvement.

Therefore, the aim of the present invention is to reduce the insertion force and improve the heat resistance of a Sn-plated material of a three-layer structure that includes a Ni layer, a Cu—Sn alloy layer, and a Sn layer, from a different standpoint from conventional ones.

### Means for Solving the Problems

The inventor made a study on other factors that affect the insertion force and the heat resistance of the Sn-plated material of the three-layer structure, and discovered that the mean crystal particle size measured when the Cu—Sn alloy layer was observed from a cross section was essential.

According to the results of experiments conducted by the inventor, the heat resistance becomes higher in case where the mean crystal particle size in the Cu—Sn alloy layer measured when the Cu—Sn alloy layer is observed from a cross section is equal to or larger than 0.05 μm but is smaller than 0.5 μm.

As the crystal particles forming the Cu—Sn alloy layer become longer in the plating thickness direction, each crystal particle comes to penetrate through the Cu—Sn alloy layer in the thickness direction. However, the grain boundary formed by those particles serves as a pipe for the Ni layer to diffuse into the Sn layer. As a result, the heat resistance becomes lower as the proportion of penetrating particles becomes larger. According to the results of the experiments conducted by the inventor, the heat resistance significantly improves when the proportion of crystal particles penetrating through the Cu—Sn alloy layer is 60% or less.

Further, it also became apparent that the mean roughness Ra of the surface of the Cu—Sn alloy layer contributed to a decrease of the insertion force, and accordingly, the roughness needed to be increased to a certain level. This is because, if the irregularities of the diffusion layer to be formed become large, the convex portions of the diffusion layer serve as supporting pillars. As a result, the Sn-plated material is prevented from being chipped off at the time of connector engagement, and the insertion force becomes smaller. However, in a case where the roughness is extremely high, the contact area between the Sn layer and the Cu—Sn layer becomes larger. As a result, diffusion of the Cu layer into the Sn layer is accelerated, and the heat resistance becomes lower. According to the results of the experiments conducted by the inventor, the mean roughness Ra of the surface of the Cu—Sn layer should be 0.1 to 0.5 μm.

Patent Document 3 certainly defines a mean crystal particle size in the Cu—Sn diffusion layer. However, the mean crystal particle size defined there is the mean crystal particle size in the surface of the Cu—Sn diffusion layer observed after the Sn layer is removed. The present invention concerns the mean crystal particle size measured when the Cu—Sn diffusion layer is observed from a cross section. The Cu—Sn diffusion layer is interposed between the base plated layer made of Ni or a Ni alloy and the surface plated layer made of Sn or a Sn alloy, and serves to prevent thermal diffusion of Ni and Sn in the thickness direction. Accordingly, a crystal particle size of the Cu—Sn diffusion layer that is defined by observing the Cu—Sn diffusion layer from a cross section is considered to excel in controlling the heat resistance. Also, the Sn—Cu layer grows in lumps. Therefore, where the surface of the Sn—Cu layer is observed after the Sn layer is removed, it is difficult to observe crystal particles due to the lumps, and the mean size cannot be measured accurately.

To manufacture the Sn-plated material of the above three-layer structure that includes a Ni layer, a Cu—Sn alloy layer, and a Sn layer, the conditions for a reflow process are important. More specifically, during the reflow process performed after a Ni layer, a Cu layer, and a Sn layer are formed on the material surface, the highest reached temperature of the plated material should be 250 to 350° C., the time required from when the surface Sn layer is melted till when the surface Sn layer is solidified by cooling should be 0.5 to 5 seconds, and the total reflow time should be 30 seconds or shorter.

One aspect of the present invention developed based on the above findings provides a Sn-plated material comprising a base plated layer made of Ni or a Ni alloy having a thickness of 0.2 to 1.5 an intermediate plated layer made of a Cu—Sn alloy having a thickness of 0.1 to 1.5 and a surface plated layer made of Sn or a Sn alloy having a thickness of 0.1 to 1.5 μm in this order on the surface of copper or a copper alloy, and the mean crystal particle size of the Cu—Sn alloy forming the intermediate plated layer is 0.05 μm or larger but is smaller than 0.5 μm when a cross section of the intermediate plated layer is observed.

In one embodiment of a Sn-plated material according to the present invention, among the crystal particles of the Cu—Sn alloy forming the intermediate plated layer, the proportion of the number of crystal particles in contact with both layers adjacent to the intermediate plated layer is 60% or less.

In another embodiment of a Sn-plated material according to the present invention, the mean surface roughness Ra of the intermediate plated layer is 0.1 to 0.3 μm.

In yet another embodiment of a Sn-plated material according to the present invention, a Cu-plated layer having a thickness of 0.3 μm or smaller is formed as a layer structure or an islands structure between the base plated layer and the intermediate plated layer.

Another aspect of the present invention provides a method for manufacturing a Sn-plated material. This method includes: forming a Ni or Ni-alloy plated layer having a thickness of 0.5 to 1.5 μm, a Cu or Cu-alloy plated layer having a thickness of 0.05 to 1.2 μm, and a Sn or Sn-alloy plated layer having a thickness of 0.3 to 1.7 μm in this order on the surface of copper or a copper alloy; and performing a reflow process where the highest reached temperature of the plated material is 250 to 350° C., the time from when the surface Sn layer is melted till when the surface Sn layer is solidified by cooling is 0.5 to 5 seconds, and the total reflow time is 30 seconds or shorter.

### ADVANTAGEOUS EFFECTS OF THE INVENTION

According to the present invention, the insertion force can be reduced, and the heat resistance can be improved in a Sn-plated material of a three-layer structure including a Ni layer, a Cu—Sn alloy layer, and a Sn layer.

### BRIEF DESCRIPTION OF THE DRAWINGS

FIG. 1 shows a TEM image obtained by performing FIB processing on a test specimen No. 3 and observing an exposed cross section of the plated layers; and

FIG. 2 shows an image in which each plated layer interface and each crystal grain boundary are added to the image shown in FIG. 1.

### EXPLANATION OF REFERENCE NUMERALS

1 substrate
2 Ni layer
3 Cu layer
4 Cu—Sn alloy layer
5 Sn layer

### BEST MODE FOR CARRYING OUT THE INVENTION

A Sn-plated material according to the present invention is basically formed by stacking a base plated layer made of Ni or a Ni alloy, an intermediate plated layer made of a Cu—Sn alloy, and a surface plated layer made of Sn or a Sn alloy in this order on the surface of a copper or copper-alloy substrate. A basic method for manufacturing the Sn-plated material having this structure includes: performing Ni or Ni-alloy plating on the surface of the copper or copper-alloy substrate; performing Cu or Cu-alloy plating; performing Sn or Sn-alloy plating; and performing a reflow process.

### Copper or Copper-Alloy Substrate

The copper or copper-alloy substrate that can be used in the present invention is not particularly limited, and any known copper or copper-alloy substrate can be used. Examples of copper alloys include brass, phosphor bronze, beryllium copper, nickel silver, red brass, titanium copper, and Corson alloy. Any of these copper alloys can be appropriately selected based on the required characteristics of electronic components such as terminals and connectors, and there are no limitations on the use of these copper alloys.

### Base Plated Layer Made of Ni or Ni Alloy

The base plated layer made of Ni or a Ni alloy is formed on the surface of the copper or copper-alloy substrate. Examples of Ni alloys include Ni—Pd alloys, Ni—Co alloys, and Ni—Sn alloys. In particular, Ni plating is preferred for the base plated layer, for Ni plating can realize a high plating rate and low costs, for example. The base plated layer can be formed by performing wet plating such as nickel electroplating or electroless nickel plating, or dry plating such as CVD or PVD. In terms of productivity and costs, electroplating is preferred.

The thickness of the base plated layer after the reflow process is 0.2 to 1.5 μm, or more preferably, 0.3 to 1.0 μm. If the thickness of the base plated layer is smaller than 0.2 μm, the substrate cannot be prevented from diffusing when heated, and the contact resistance becomes higher. If the thickness of the base plated layer after the reflow becomes larger than 1.0 μm, on the other hand, this may cause cracks during the bending process. Since the thickness of the base plated layer hardly vary before and after the reflow process, it is sufficient that the base plating be performed to obtain a thickness within the above mentioned range before the reflow process in order that the thickness of the base plated layer after the reflow process can fall within the above mentioned range.

### Intermediate Plated Layer Made of Cu—Sn Alloy

The thickness of the intermediate plated layer made of a Cu—Sn alloy after the reflow process is 0.1 to 1.5 μm, or more preferably, 0.3 to 1.0 μm. As Cu—Sn alloy is hard, the existence of an intermediate plated layer of 0.1 μm or greater in thickness contributes to a decrease in insertion force. On the other hand, if the thickness of the intermediate plated layer becomes larger than 1.5 vim, it may cause cracks during the bending process.

To form the intermediate plated layer of such a thickness, the thickness of the Cu or Cu-alloy plated layer prior to the reflow process should be 0.05 to 1.2 μm, or more preferably, 0.1 to 0.5 μm. If the thickness of the Cu or Cu-alloy plated layer is smaller than 0.05 μm, the thickness of the obtained Cu—Sn alloy layer becomes insufficient. If the thickness of the Cu or Cu-alloy plated layer is larger than 1.2 μm, on the other hand, the thickness of the obtained Cu—Sn alloy layer becomes too large, or the Cu-plated layer is likely to remain after the reflow process.

The Cu or Cu-alloy plated layer is consumed by the formation of the Cu—Sn alloy layer during the reflow process, and the maximum thickness of the Cu or Cu-alloy plated layer preferably becomes smaller than 0.3 μm, or more preferably becomes zero. If the Cu or Cu-alloy plated layer remains, the remaining Cu or Cu-alloy plated layer forms a Cu—Sn alloy layer by consuming the Sn-plated layer on the surface while being left at a high temperature for a long period of time. This results in degradation of contact resistance and solderability. However, if the Sn-plated layer is still in a melted state (an over reflow state) after all the Cu-plated layer is consumed, a Ni-plated layer might diffuse into the melted Sn-plated layer, resulting in an undesirable situation. Therefore, the Cu-plated layer is not reduced to zero, and specifically, more than zero and less than 0.3 μm of the Cu-plated layer may be intentionally left. When the Cu-plated layer remains, the remaining Cu-plated layer may be in a layer structure or an islands structure.

Examples of “Cu or Cu-alloy plating” prior to the reflow process include not only Cu plating but also copper alloy plating such as Cu—Ni alloy plating, Cu—Zn alloy plating, and Cu—Sn alloy plating. Among these kinds of plating, Cu plating is particularly preferred, because plating bath control is easy, a uniform film can be obtained, and costs are low. The Cu or Cu-alloy plated layer can be formed by performing wet plating such as copper electroplating or electroless copper plating, or dry plating such as CVD or PVD. In terms of productivity and costs, electroplating is preferred.

When Cu alloy plating is employed as the Cu or Cu-alloy plating, or where Sn alloy plating is employed as the Sn or Sn-alloy plating as will be described later, the Cu—Sn alloy plating might involve an element other than Cu and Sn. Such a case is also referred to as the “Cu—Sn alloy plating” in the present invention.

The mean particle size of the crystal particles of the Cu—Sn alloy forming the intermediate plated layer affects the heat resistance of the Sn-plated material. The mean particle size is preferably small. Specifically, the mean crystal particle size of the Cu—Sn alloy is in the range of 0.05 μm or larger and smaller than 0.5 μm when the intermediate plated layer is observed in a cross section. The mean crystal particle size of the crystal particles of the Cu—Sn alloy is preferably smaller than 0.4 μm. However, if the crystal particle size is too small, the strength of the Cu—Sn alloy layer becomes higher, and the bending workability becomes poorer. Therefore, the mean particle size of the crystal particles is preferably equal to or larger than 0.05 μm. The mean crystal particle size of the Cu—Sn alloy forming the intermediate plated layer according to the present invention is typically in the range of 0.2 to 0.4 μm.

The heat resistance becomes lower as the proportion of crystal particles penetrating through the intermediate layer becomes larger among the crystal particles of the Cu—Sn alloy forming the intermediate layer. Accordingly, the proportion of those penetrating particles should preferably be small. Specifically, the proportion of the crystal particles penetrating through the Cu—Sn alloy layer is equal to or less than 60%, or more preferably, equal to or less than 50%. A typical proportion of penetrating particles is 30 to 60%. In the present invention, the proportion of penetrating particles is the proportion of the number of crystal particles that are in contact with both layers adjacent to the plated layer among the crystal particles of the Cu—Sn alloy forming the intermediate plated layer.

Furthermore, the mean roughness Ra of the surface of the intermediate plated layer made of a Cu—Sn alloy affects the insertion force, and the surface of the intermediate plated layer should preferably have a certain high degree of roughness. If the roughness becomes too high, however, the contact area between the Sn layer and the Cu—Sn layer becomes larger. As a result, diffusion of the Cu layer into the Sn layer is accelerated, and the heat resistance becomes lower. Therefore, the mean roughness Ra of the surface of the intermediate plated layer is set at 0.1 to 0.5 μm. The mean roughness Ra of the surface of the intermediate plated layer is preferably 0.1 to 0.3 μm, or more preferably 0.15 to 0.25 μm.

While the Sn is in a melted state, the Cu melts and diffuses into the Sn. As the Cu diffuses in a wave-like manner, a Cu—Sn alloy layer surface with high surface roughness is formed. As the Sn stays in the melted state longer, the Cu diffuses further, and the roughness becomes higher. If the time between melting and solidifying is longer than 5 seconds, the surface roughness of the Cu—Sn alloy layer is likely to exceed 0.5 μm. Therefore, the time between melting and solidifying is preferably equal to or shorter than 5 seconds. In view of the production lines, on the other hand, if the time between melting and solidifying is shorter than 0.5 seconds, there is a high possibility that unmelted portions appear, and it becomes difficult to obtain a Cu—Sn alloy layer having a certain thickness. The surface roughness of the Cu—Sn alloy is normally equal to or higher than 0.1 μm, unless a gloss agent or an additive agent is added.

As the total reflow time becomes longer, the diffusion of the Cu into the Sn progresses further, and the particles of the formed Cu—Sn alloy grow further. If the total reflow time is longer than 30 seconds, the crystal particle size will become 0.5 μm or larger when the Cu—Sn alloy layer is observed in a cross section.

As for the conditions of the reflow process, the temperature should preferably be as low as possible. If a reflow process is performed at a relatively low temperature, excess melting and diffusion of Cu is prevented. Not only consumption of pure Sn is suppressed, but also new crystal particles are easily formed during diffusion. Accordingly, crystal particles that penetrate through the Ni layer and reach the Sn layer are hardly formed. However, if the temperature is too low, reflow defects occur. Therefore, the highest reached temperature of the plated material should be 250 to 350° C. as a requirement for the reflow process.

In view of this, to control the mean crystal particle size, the proportion of penetrating particles, and the mean roughness Ra of the Cu—Sn alloy forming the intermediate plated layer, it is essential to satisfy the following requirements: during the reflow process, the highest reached temperature of the plated material is set at 250 to 350° C., or more preferably 280 to 320° C.; the time required between the melting of the surface Sn layer and the solidifying of the surface Sn layer through cooling is set at 0.5 to 5 seconds, or more preferably 0.5 to 2 seconds; and the total reflow process time is set within 30 seconds, or more preferably 5 to 15 seconds.

The time required between the melting of the surface Sn layer and the solidifying of the surface Sn layer through cooling is determined by measuring the glossiness of the surface with a reflection densitometer to confirm the timing of the melting of Sn, starting cooling, and measuring the timing for the temperature of the plated material to become lower than the melting point of Sn.

The total reflow process time is determined by measuring the time from when the temperature of the plated material reaches 50° C. till when the temperature returns to 50° C. after reaching the reflow temperature.

### Surface Plated Layer Made of Sn or Sn-Alloy

The thickness of the surface plated layer made of Sn or a Sn alloy after the reflow process is 0.1 to 1.5 μm, or more preferably 0.2 to 1.0 μm. If the thickness of the surface plated layer becomes smaller than 0.1 μm, degradation of solder wettability and contact resistance under high temperatures is rapidly accelerated. If the thickness of the surface plated layer becomes greater than 1.5 μm, the insertion force becomes remarkably large. To adjust the thickness of the surface plated layer within the above mentioned range after the reflow process, the thickness of the surface plated layer prior to the reflow process should preferably be 0.3 to 1.7 μm, or more preferably 0.4 to 1.2 μm. If the thickness of the surface plated layer prior to the reflow process is smaller than 0.3 μm, the Sn components are consumed, diffusing into the Cu or Cu-alloy plated layer due to the reflow process. As a result, a surface plated layer of a required thickness will not remain after the reflow process. If the thickness of the surface plated layer prior to the reflow process is larger than 1.7 μm, a surface plated layer with an excessive thickness will remain even after the reflow process.

Examples of the “Sn or a Sn alloy” include not only Sn plating but also Sn alloy plating such as Sn—Ag alloy plating, Sn—Bi alloy plating, Sn—Zn alloy plating, and Sn—Pb alloy plating. Among these kinds of plating, Sn plating is particularly preferred, because a plating bath is safe and plating bath control is easy, and a heat treatment can be performed at a relatively low temperature. The Sn or Sn-alloy plated layer can be formed by performing wet plating such as Sn electroplating or electroless Sn plating, or dry plating such as CVD or PVD. In terms of productivity and costs, electroplating is preferred.

### EXAMPLES

Examples of the present invention are described below. However, these examples are described for illustrative purpose only, and the present invention is not limited thereto.

### 1. Evaluation Method

Each test specimen was evaluated in the following manner.

### [Plating Thickness]

The thickness of the Ni-plated layer prior to the reflow process was measured with a fluorescent X-ray film thickness meter (manufactured by SII NanoTechnology Inc., Model: SEA5100). The thickness of the Cu-plated layer was measured with an electrolytic film thickness meter (manufactured by Densoku Co., Ltd., Model: CT-3), with Cu plating being performed over the Ni plating. The thickness of the Sn-plated layer was measured with the above fluorescent X-ray film thickness meter. The mean value of the thicknesses measured at five different portions of each plated layer was set as the thickness of the plated layer.

The thickness of the Ni-plated layer after the reflow process was measured by the above fluorescent X-ray film thickness meter. The thickness of the Cu-plated layer and the thickness of the Sn-plated layer were measured with the above electrolytic film thickness meter. The mean value of the thicknesses measured at five different portions of each plated layer was set as the thickness of the plated layer. Cross-section observations were then made with a TEM. The field of view was divided into nine equal parts in the width direction, and the thicknesses at 0, 1, 2, 3, 4, 5, 6, 7, 8, and 9 (ten points in total) of the Cu—Sn diffusion layer were measured, with the entire width being 9. The mean value of the measured values was set as the thickness of the Cu—Sn diffusion layer.

### [Mean Crystal Particle Size of the Cu—Sn Alloy Forming the Intermediate Plated Layer]

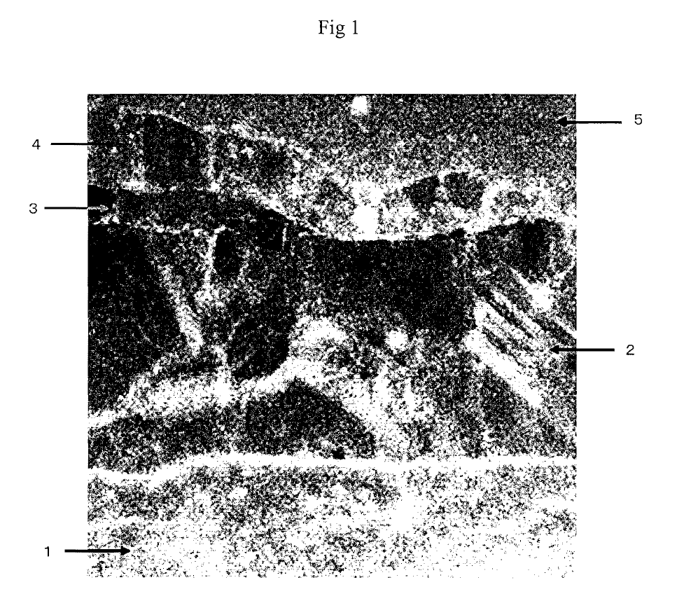

After each test specimen was processed with a focused ion beam processing observation apparatus FB-2100 (manufactured by Hitachi, Ltd.) to expose plating cross sections, cross sections of the intermediate plated layer made of a Cu—Sn alloy were observed (magnification: 27800, field of view 1.3 μm×1.3 μm) with a transmission electron microscope (TEM) HD-2700 (accelerating voltage: 200 kv, beam size: 0.2 nm) manufactured by Hitachi. With respect to each crystal particle of the Cu—Sn alloy, the longest straight line that can be drawn in the plating thickness direction, and the longest straight line that can be drawn in a direction perpendicular to the plating thickness direction were actually measured, and the size of each crystal particle was calculated from the mean value of the two longest straight lines. The sizes of all the crystal particles of the Cu—Sn alloy existing in the field of view were calculated in this manner, and the mean value of the sizes was set as the mean crystal particle size of the Cu—Sn alloy. FIG. 1 shows an example of a TEM image obtained from No. 3 specimen when the cross section of the intermediate plated layer of a Cu—Sn alloy was observed for an illustrative purpose.

### [Proportion of the Cu—Sn Alloy Particles Penetrating the Intermediate Plated Layer]

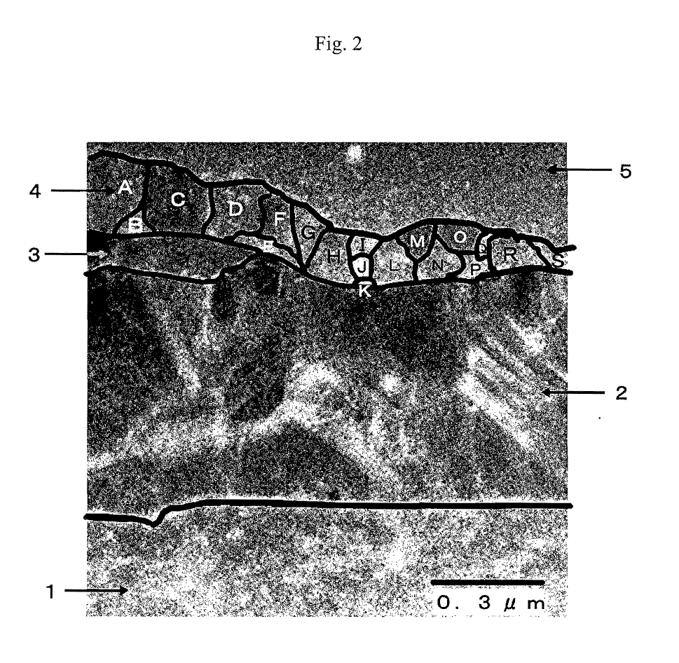

After each test specimen was processed with the focused ion beam processing observation apparatus FB-2100 (manufactured by Hitachi, Ltd.) to expose plating cross sections, cross sections of the intermediate plated layer made of a Cu—Sn alloy were observed (magnification: 27800, field of view 1.3 μm×1.3 μm) with the transmission electron microscope (TEM) HD-2700 (accelerating voltage: 200 kv, beam size: 0.2 nm) manufactured by Hitachi. The crystal particles that are in contact with both adjacent plated layers (the Ni-plated layer or the Cu-plated layer, and the Sn layer) were regarded as penetrating particles. The number of all crystal particles of the Cu—Sn alloy existing in the field of view, and the number of penetrating particles among the crystal particles were counted, and the proportion of the penetrating particles was calculated. FIG. 1 shows the example of the TEM image obtained when the No. 3 cross section of the intermediate plated layer of a Cu—Sn alloy was observed for an illustrative purpose. In FIG. 2, the plated layer interfaces and the crystal grain boundaries are added to the drawing of FIG. 1, and each crystal particles is denoted by an alphabet. Among the 19 crystal particles A through S, the seven crystal particles A, C, D, H, L, R, and S are penetrating particles. Therefore, the proportion of the penetrating particles is 7/19=36.8% (approximately 35%).

### [Mean Roughness (Ra) of the Surface of the Cu—Sn Alloy Plated Layer]

After the surface Sn layer of each test specimen was chemically ground and was completely removed, the roughness of the surface of the Cu—Sn alloy layer was measured with a noncontact-type three-dimensional measuring device NH-3 (a He—Ne laser, wavelength: 633 nm, power: 1.8 mW) (manufactured by Mitaka Kohki Co., Ltd.).

### [Solderability]

After each test specimen was heated in the atmosphere at 155° C. for 16 hours, the solderability was measured. The solder wetting time T₂ was measured by a meniscograph test with the use of a solder checker SAT-5000 (manufactured by Rhesca Corporation). The sample size: 10 mm in width, 20 mm in length; Flux: a 25% rosin-methanol solution; Solder temperature: 250° C.; Solder composition: Sn-3.0Ag-0.5Cu (705M, manufactured by Senju Metal Industry Co., Ltd.); Immersion rate: 20 mm/sec; Immersion period: 10 seconds; Immersion depth: 2 mm.

### [Contact Resistance]

After each test specimen was heated in the atmosphere at 155° C. for 1000 hours, the contact resistance was measured by a four-terminal method with the use of an electric contact simulator CRS-1 (manufactured by Yamasaki-Seiki Co., Ltd.). Probe: gold probe; Contact load: 50 g; Sliding rate: 1 mm/min; Sliding distance: 1 mm.

### [Insertion Force]

After each test specimen was pressed to form a 090-model male terminal (width: 2.3 mm, thickness: 0.64 mm), the load to engage the male terminal with a female terminal was measured with a desktop load measuring instrument 1310NR (manufactured by Aikoh Engineering Co., Ltd.). Female terminal: a 090-model SMTS terminal (manufactured by Sumitomo Wiring Systems, Ltd.); Insertion rate: 50 mm/min; Insertion distance: 5 mm/min.

### 2. Production of Test Specimens

Seventeen copper alloy strips (thickness: 0.32 mm, width: 30 mm, length: 100 mm) each having a composition containing 30 mass % of Zn, the remaining mass % of Cu, and inevitable impurities were prepared, and plating was performed on each of the strips in the following manner.

(Procedure 1) Electrolytic degreasing was performed in an alkaline aqueous solution, with a sample being a cathode.

(Procedure 2) The sample was pickled with a 10 mass % sulfuric acid aqueous solution.

(Procedure 3) With the use of a nickel plating bath containing 250 g/L of nickel sulfate, 45 g/L of nickel chloride, and 40 g/L of boric acid, Ni plating was performed at a temperature of 55° C. and a current density of 4.0 A/dm². The thickness of the Ni-plated layer was adjusted by controlling the electrodeposition time. Table 1 shows the thickness of the Ni-plated layer of each test specimen observed at this point in time.

(Procedure 4) With the use of a copper plating bath containing 200 g/L of copper sulfate and 60 g/L of sulfuric acid, Cu plating was performed at a temperature of 30° C. and a current density of 2.3 A/dm². The thickness of the Cu-plated layer was adjusted by controlling the electrodeposition time. Table 1 shows the thickness of the Cu-plated layer of each test specimen observed at this point in time.

(Procedure 5) With the use of a Sn plating bath containing 40 g/L of stannous oxide, 270 g/L of phenolsulfonic acid, and 5 g/L of a surfactant agent, Sn plating was performed at a temperature of 45° C. and a current density of 4.0 A/dm². The thickness of the Sn-plated layer was adjusted by controlling the electrodeposition time. Table 1 shows the thickness of the Sn-plated layer of each test specimen observed at this point in time.

(Procedure 6) The reflow process was then performed under the conditions specified in Table 1. Table 1 also shows the plating thickness of each test specimen observed after the reflow process.

TABLE 1

| | | | | Requirements for reflow | | | | | | |
|---|---|---|---|---|---|---|---|---|---|---|
| | Plating thickness | | | Highest | Time between melting | | Plating thickness | | | |
| | prior to reflow (μm) | | | temperature of | and solidifying | Total reflow | after reflow (μm) | | | |
| No. | Ni | Cu | Sn | material (° C.) | (seconds) | time (seconds) | Ni | Cu | CuSn | Sn |
| 1 | 0.5 | 0.2 | 0.8 | 300 | 1 | 8 | 0.5 | 0 | 0.38 | 0.58 |
| 2 | 1.2 | 0.3 | 0.7 | 300 | 1 | 8 | 1.2 | 0.25 | 0.41 | 0.45 |
| 3 | 0.6 | 0.25 | 1.3 | 300 | 1 | 8 | 0.6 | 0.12 | 0.20 | 1.12 |
| 4 | 0.9 | 0.25 | 1 | 280 | 1 | 10 | 0.9 | 0.05 | 0.42 | 0.86 |
| 5 | 0.6 | 0.2 | 0.6 | 280 | 1 | 10 | 0.6 | 0 | 0.4 | 0.34 |
| 6 | 0.6 | 0.3 | 0.6 | 300 | 1 | 8 | 0.6 | 0.1 | 0.38 | 0.42 |
| 7 | 0.9 | 0.4 | 1.3 | 280 | 10 | 25 | 0.9 | 0 | 0.82 | 0.9 |
| 8 | 0.6 | 0.2 | 0.8 | 400 | 2 | 5 | 0.6 | 0 | 0.43 | 0.59 |
| 9 | 1.2 | 0.5 | 1 | 250 | 5 | 45 | 1.2 | 0 | 0.94 | 0.54 |
| 10 | 0.6 | 0.3 | 0.9 | 250 | 5 | 60 | 0.6 | 0 | 0.61 | 0.6 |
| 11 | 0.1 | 0.3 | 0.5 | 280 | 1 | 10 | 0.1 | 0.1 | 0.4 | 0.3 |
| 12 | 0.9 | 0.9 | 0.9 | 280 | 1 | 10 | 0.9 | 0.63 | 0.51 | 0.68 |
| 13 | 0.4 | 0.1 | 1.1 | 280 | 0.05 | 10 | 0.4 | 0.09 | 0.05 | 1 |
| 14 | 0.6 | 0.2 | 0.25 | 280 | 1 | 10 | 0.6 | 0 | 0.32 | 0.08 |
| 15 | 0.6 | 0.4 | 2 | 280 | 1 | 10 | 0.6 | 0.12 | 0.45 | 1.82 |
| 16 | none | 0.3 | 0.8 | 280 | 1 | 10 | none | 0.12 | 0.3 | 0.71 |
| 17 | 0.6 | none | 0.8 | 280 | 1 | 10 | 0.42 | none | — | 0.48 |

### 3. Results

Table 2 shows the results of evaluations made on the properties of each of the test specimens obtained through the above described procedures.

TABLE 2

| | | | | Properties | | |
|---|---|---|---|---|---|---|
| | Cu—Sn alloy plated layer | | | | Contact | |
| | Particle | Penetrating | Roughness | Solderability | resistance | Insertion |
| No. | size (μm) | particles (%) | (μm) | (seconds) | (mΩ) | force (N) |
| 1 | 0.42 | 55 | 0.30 | 1.5 | 2 | 4.7 |
| 2 | 0.36 | 50 | 0.21 | 2.2 | 5.5 | 4.7 |
| 3 | 0.12 | 35 | 0.25 | 1 | 2 | 5.5 |
| 4 | 0.18 | 20 | 0.20 | 1.2 | 1.8 | 5.1 |
| 5 | 0.05 | 0 | 0.12 | 2.5 | 6.7 | 4.5 |
| 6 | 0.43 | 50 | 0.05 | 2.7 | 4.7 | 5.4 |
| 7 | 0.38 | 50 | 0.60 | 5.4 | 28 | 5.1 |
| 8 | 0.45 | 80 | 0.27 | 4.5 | 25 | 4.8 |
| 9 | 0.72 | 55 | 0.32 | 3.2 | 15 | 4.7 |
| 10 | 1.66 | 60 | 0.19 | 4.2 | 25 | 5 |
| 11 | 0.46 | 35 | 0.32 | 10 seconds | 52 | 4.4 |
| | | | | or longer | | |
| 12 | 0.41 | 50 | 0.40 | 10 seconds | 38 | 5 |
| | | | | or longer | | |
| 13 | 0.35 | 45 | 0.42 | 10 seconds | 113 | 5.3 |
| | | | | or longer | | |
| 14 | 0.3 | 55 | 0.32 | 10 seconds | 18 | 4.2 |
| | | | | or longer | | |
| 15 | 0.38 | 50 | 0.28 | 1 | 4.5 | 6.8 |
| 16 | 0.4 | 45 | 0.36 | 3.4 | 40 | 5.1 |
| 17 | — | — | — | 10 seconds | 130 | 4.8 |
| | | | | or longer | | |

As for each of specimens No. 1 through No. 5, not only the plating thickness of each layer after the reflow process but also the particle size, the penetrating particles, and the surface roughness of the Cu—Sn alloy plated layer fall within the respective preferred ranges. After the heating process, each of those specimens exhibits excellent solderability and contact resistance, and also has high insertion properties.

Specimen No. 6 is an example in which the surface roughness of the Cu—Sn alloy plated layer is low. Comparing specimen No. 2 and specimen No. 6, the respective plating thicknesses after the reflow process are close to each other, and the particle sizes of the crystal particles and the proportions of the penetrating particles in the Cu—Sn alloy plated layer are also close to each other. However, the Cu—Sn alloy plated layer of specimen No. 2 has higher surface roughness than that of specimen No. 6, and specimen No. 2 has smaller insertion force than that of specimen No. 6.

Specimen No. 7 is an example in which the surface roughness of the Cu—Sn alloy plated layer is high. Therefore, the contact resistance after the heating process is high.

Specimen No. 8 is an example in which the proportion of the penetrating particles in the Cu—Sn alloy plated layer is high. Comparing specimen No. 1 and specimen No. 8, the respective plated thicknesses after the reflow process are close to each other, and the particle sizes of the crystal particles and the surface roughness for the Cu—Sn alloy plated layer are also close to each other. However, the proportion of the crystal particles penetrating through the Cu—Sn alloy plated layer is large in specimen No. 8, and the contact resistance after the heating process is higher in specimen No. 8.

Specimen No. 9 is an example in which the mean particle size of the crystal particles in the Cu—Sn alloy plated layer is large. Comparing specimen No. 2 and specimen No. 9, the respective plating thicknesses after the reflow process are close to each other, and the proportions of the crystal particles penetrating through the Cu—Sn alloy plated layer are also close to each other. However, the size of the crystal particles forming the Cu—Sn alloy plated layer of specimen No. 9 is much larger than that of specimen No. 2. As a result, the contact resistance of specimen No. 9 is poorer.

Specimen No. 10 is an example in which the mean particle size of the crystal particles of the Cu—Sn alloy plated layer is even larger. Comparing specimen No. 1 and specimen No. 10, the respective plating thicknesses after the reflow process are close to each other, and the proportions of the crystal particles penetrating through the Cu—Sn alloy plated layer are also close to each other. However, the size of the crystal particles forming the Cu—Sn alloy plated layer of specimen No. 10 is much larger than that of specimen No. 1. As a result, the contact resistance of specimen No. 10 is poorer.

Specimen No. 11 is an example in which the thickness of the Ni-plated layer is too small, and specimen No. 12 is an example in which the thickness of the Cu-plated layer is too large. Specimen No. 13 is an example in which the thickness of the Cu—Sn alloy plated layer is too small, and specimen No. 14 is an example in which the thickness of the Sn-plated layer is too small. In any of those examples, the heat resistance is remarkably low.

Specimen No. 15 is an example in which the thickness of the Sn-plated layer is too large. In this example, the insertion force is remarkably large.

Specimen No. 16 is an example in which only the Cu base plating and the Sn surface plating are performed. In this example, the heat resistance is low.

Specimen No. 17 is an example in which only the Ni base plating and the Sn surface plating are performed. In this example, the solderability and the heat resistance are both poor.

1. A Sn-plated material comprising a base plated layer made of Ni or a Ni alloy having a thickness of 0.2 to 1.5 μm, an intermediate plated layer made of a Cu—Sn alloy having a thickness of 0.1 to 1.5 μm, and a surface plated layer made of Sn or a Sn alloy having a thickness of 0.1 to 1.5 μm in this order on the surface of copper or a copper alloy, and the mean crystal particle size of the Cu—Sn alloy forming the intermediate plated layer is 0.05 μm or larger but is smaller than 0.5 lam when a cross section of the intermediate plated layer is observed.

2. A Sn-plated material according to claim 1, wherein among the crystal particles of the Cu—Sn alloy forming the intermediate plated layer, the proportion of the number of crystal particles in contact with both layers adjacent to the intermediate plated layer is 60% or less.

3. A Sn-plated material according to claim 1, wherein the mean surface roughness Ra of the intermediate plated layer is 0.1 to 0.5 μm.

4. A Sn-plated material according to claim 1, wherein a Cu-plated layer having a thickness of 0.3 μm or smaller is formed in a layer structure or an islands structure between the base plated layer and the intermediate plated layer.

5. A method for manufacturing a Sn-plated material comprising forming a Ni or Ni-alloy plated layer having a thickness of 0.2 to 1.5 μm, a Cu or Cu-alloy plated layer having a thickness of 0.05 to 1.2 μm, and a Sn or Sn-alloy plated layer having a thickness of 0.3 to 1.7 μm in this order on the surface of copper or a copper alloy; and performing a reflow process in which the highest reached temperature of the plated material is 250 to 350° C., the time from when the surface Sn layer is melted till when the surface Sn layer is solidified by cooling is 0.5 to 5 seconds, and the total reflow time is 30 seconds or shorter.
